(19) United States
(12) Patent Application Publication
(10) Pub. No.: US 2016/0021171 A1
(43) Pub. Date: Jan. 21, 2016

(54) DATACENTER EVENT STREAM PROCESSING IN A NETWORK-BASED COMMUNICATION SYSTEM

(71) Applicant: Jive Communications, Inc., Orem, UT (US)

(72) Inventor: Theo Peter Zourzouvillys, Orem, UT (US)

(21) Appl. No.: 14/335,541

(22) Filed: Jul. 18, 2014

(51) Int. Cl. H04L 29/08; H04L 29/06

(52) U.S. Cl. CPC H04L 67/10; H04L 65/60

(57) ABSTRACT

The present application details exemplary methods and systems for processing an event stream at one or more datacenters within a network-based communication system. For example, a datacenter can detect an event that occurs within the network-based communication system. Upon detecting the event, the datacenter can create an event message and send the event message to other datacenters in the network-based communication system. Each datacenter that receives the event message from the datacenter can process the event message to obtain event information and can store the event information in association with a context, such as a user account.

### BACKGROUND

1. Technical Field

One or more embodiments disclosed herein relate generally to facilitating communications over a network. More specifically, one or more embodiments disclosed herein relate to updating information at one or more datacenters within a network-based communication system.

2. Background and Relevant Art

Advances in electronic communications technologies have interconnected people and allowed for better communication. To illustrate, users traditionally relied on a public switched telephone network (“PSTN”) to speak with other users in real-time. Now, users may communicate using network or Internet-based communication systems. One such network-based communication system is an Internet protocol (“IP”) telephone system, such as a voice over IP (“VoIP”) communication system.

Conventional network-based communication systems commonly rely on a central datacenter to provide communication services for each network device. For example, the central datacenter can provide VoIP services, such as facilitating VoIP communication sessions (e.g., voice and video calls), to one or more network devices. In addition, in many conventional network-based communication systems a backup datacenter provides an available option to restore the communication services in the event the central datacenter fails (e.g., network failure, hardware failure, datacenter maintenance).

A number of disadvantages exist with respect to conventional network-based communication systems. For example, conventional network-based communication systems include a large amount of redundancy, overhead, and inefficiency in maintaining duplicate backup datacenters. In addition to low utilization efficiency, traditional VoIP systems commonly experience bottlenecking issues at the central datacenter when network loads increase. For example, as the number of network devices using the VoIP system increases, the limited resources of the central datacenter may become overloaded, which in turn can reduce the quality of service available to users.

The central datacenter/backup datacenter model may also increase the possibility of system failure. For example, disruptions, such as a power failure, may cripple the network-based communication system until the network-based communication system can shift operations to the backup datacenter. As often is the case, users on a call during an outage will lose the call completely and often must wait for the service provider to restore service by shifting the operations to the backup datacenter.

Further, for many conventional network-based communication systems, switching from the central datacenter to a backup datacenter is a complicated process, and often requires substantial manual intervention. For example, conventional network-based communication systems must re-register each network device with new addresses corresponding to the backup datacenter, and reestablish current calls via the backup datacenter. Additionally, conventional network-based communication systems must migrate user settings, voice-messages, etc., for each network device from the central datacenter to the backup datacenter.

To avoid losing important information, many conventional network-based communication systems use one or more remote services (e.g., one or more servers remote from the central datacenter) for maintaining and updating user account information. For example, the central datacenter may communicate with a remote accounting service to provide accounting information (e.g., account balances) to the central datacenter. In addition, the central datacenter may use a remote voicemail provider to provide voicemail service to the central datacenter.

Although remote services provide some assurances to a permanent loss of information in the event of a central datacenter failure, using remote services within a network-based communication system can have several disadvantages. For example, a loss of communication between a remote service and the central datacenter can present numerous problems. While communication between the central datacenter and a remote service is disrupted, some services may not be accessible because services provided by the remote service, and information stored at the remote service is inaccessible during the disruption.

For example, if the central datacenter receives voicemail services from a remote voicemail service provider, a user may not be able to access voicemail services or messages during a loss of communication between the datacenter and the remote voicemail service provider. In addition, the remote voicemail service provider cannot communicate to a user when new voicemails are received because the connection with the central datacenter is down. Thus, when the central datacenter loses connection with remote services, the user again must wait until the connection is restored before being able to access services provided by the remote service because the user's voicemail information is store at the remote service.

As another example, service charges from a communication between two users may not be properly deducted from the user account balance because the communication between the central datacenter and a remote accounting service failed before the remote accounting service properly applied the deduction. Further, when the network-based communication system reestablishes communication with the remote service, the account balance information provided to the datacenter is incorrect, resulting in lost revenue for the system provider, and potentially causing customer confusion. As such, all transactions, setting changes, calls logs, etc., which depend or interact with remote services may experience similar issues in the event of a communication loss between the datacenter and a remote service.

Additionally, the use of remote services in conventional network-based communication systems can lead to data conflicts in the event of a communication loss between the datacenter and the remote service. For example, following a communication disruption between a central datacenter and a remote service, and after communication is restored, the central datacenter may send unprocessed transactions to the remote service to be processed. Depending on how long the central datacenter connection was down, the unprocessed transactions may conflict with transactions that occurred during the communication loss. Examples of conflicts that result in user confusion may include, but are not limited to, user passwords changes, account balance deposit and debit modifications, status changes associated with voicemail messages, user settings changes, etc.

Accordingly, a number of considerations can be made in improving updating and maintaining information associated with network-based communication systems.

### BRIEF SUMMARY

Embodiments disclosed herein provide benefits and/or solve one or more of the foregoing or other problems in the art with systems and methods that process an event stream at one or more datacenters within a network-based communication system. In particular, example embodiments include systems and methods that allow one or more datacenters to independently process event messages, in non-real time, for each event associated with a network device and/or user account within the network-based communication system.

In one or more embodiments, the systems and methods disclosed herein can detect events, create event messages, and dynamically process event messages at a datacenter. For example, one or more embodiments include systems and methods to detect an event associated with a network device, and create event messages for each detected event. In addition, one or more embodiments disclosed herein provide systems and methods for sending and organizing event messages in an event queue located at a datacenter. In some example embodiments, the datacenter processes each event message per the event queue.

The systems and methods disclosed herein can provide for dynamically processing event messages at multiple datacenters. For instance, each datacenter in the network-based communication system may receive event messages (referred to as a “event stream”) from other datacenters within the network-based communication system. Each datacenter may add the event messages in the event stream into an event queue and process the event messages. Thus, one or more embodiments include systems and methods for using event messages to update information at multiple datacenters within a network-based communication system.

In addition, one or more embodiments include systems and methods to provide event messages that include event information, such as the user account associated with the event, and the type of event. As each datacenter processes event messages, each datacenter can extract event information to update state information associated with a user account. In this manner, each datacenter can maintain a copy of state information for each user account. Accordingly, each datacenter can provide a user with user account information without the need to rely of a remote service to provide that information. Further, if one datacenter experiences a network disruption, the other datacenters within the network-based communication system are unaffected and can still provide users access to user account information and service.

Additional features and advantages disclosed herein will be set forth in the description which follows, and in part will be obvious from the description, or may be learned by the practice of such exemplary embodiments. The features and advantages of such embodiments may be realized and obtained by means of the instruments and combinations particularly pointed out in the appended claims. These and other features will become more fully apparent from the following description and appended claims, or may be learned by the practice of such exemplary embodiments as set forth hereinafter.

### BRIEF DESCRIPTION OF THE DRAWINGS

In order to describe obtaining the above recited and other advantages and features of the invention, a more particular description of one or more embodiments briefly described above will be rendered by reference to specific embodiments thereof that are illustrated in the appended drawings. It should be noted that the figures are not drawn to scale, and that elements of similar structure or function are generally represented by like reference numerals for illustrative purposes throughout the figures. Understanding that these drawings depict only typical embodiments of the invention and are not therefore to be considered limiting of its scope, the invention will be described and explained with additional specificity and detail through the use of the accompanying drawings in which:

FIG. 1 illustrates a network-based communications system in accordance with one or more embodiments disclosed herein;

FIG. 2 illustrates an map where the network-based communication system of FIG. 1 may be utilized in accordance with one or more embodiments disclosed herein;

FIG. 3 illustrates a more detailed network-based communication system in accordance with one or more embodiments disclosed herein;

FIG. 4 illustrates a sequence-flow diagram illustrating processing an event stream in accordance with one or more embodiments disclosed herein;

FIG. 5 illustrates another sequence-flow diagram illustrating processing an event stream in accordance with one or more embodiments disclosed herein;

FIG. 6 illustrates a method of processing event messages at one or more datacenters within the network-based communication system in accordance with one or more embodiments disclosed herein;

FIG. 7 illustrates another exemplary method of processing event messages at one or more datacenters within the network-based communication system in accordance with one or more embodiments disclosed herein;

FIG. 8 illustrates a block diagram of an exemplary computing device according to the principles described herein; and

FIG. 9 illustrates an example network environment of a network-based communication system according to the principles described herein.

### DETAILED DESCRIPTION

Embodiments disclosed herein provide benefits and/or solve one or more of the abovementioned problems or other problems in the art with improving user communication in a network-based communication system. In particular, one or more example embodiments allow one or more datacenters to process an event stream within a network-based communication system. For example, one or more embodiments include a network-based communication system that allows multiple datacenters to each process event streams that include events associated with user accounts and/or network devices.

In some example embodiments, a network device may concurrently connect to multiple datacenters. For example, a network device may map to and register with both a first datacenter and a second datacenter. For instance, the network device may be communicating with the first datacenter when a connection error occurs. Because the network device also connects with the second datacenter, the network device may switch communications to the second datacenter. In this manner, the network device may switch connections between the first datacenter and the second datacenter because the network device is connected to both datacenters at the same time. Thus, unlike conventional Internet Protocol (“IP”) communication systems described above, where a network device is connected to only the central datacenter, embodiments herein disclose a network-based communication system that allows a network device to connect with multiple datacenters simultaneously. Additional detail regarding connecting to multiple datacenters at the same time is provided in U.S. application Ser. No. 14/335,103, (Attorney Docket No. 20029.1.1), the contents of which is incorporated herein by reference in its entirety.

However, if a network device connects with multiple datacenters at the same time, there arises the potential for conflicts between state information between the multiple datacenters. For example, if the network device is performing one event that only the first datacenter detects and processes, the second datacenter may not receive information about the event. Accordingly, state information is not updated as the second datacenter. The first datacenter would need to send a copy of the state information for a context, such as a user account, to the second datacenter. However, conflicting state information arises for a context between the two datacenters if each datacenter detects an event for the same context (e.g., user account), and the events occur around the same time. Further, neither datacenter has the correct state information. Accordingly, the network-based communication system can resolve conflicts and minimize user confusion by employing event queues and processing event streams independently at each datacenter.

In one or more embodiments, a user may trigger an event, such as by preforming an action. For example, a user may change a user account setting, add funds to the user account, request additional services, etc. When an event occurs, the network-based communication system may detect the event and create an event message. In other words, the network-based communication system may create event messages as users perform various actions that trigger events. The event message can include event information, such as the type of event detected, the network device associated with the event (if any), the user context associated with the event, and/or other information, as will be described in greater detail below. In some example embodiments, the network-based communication system may configure a datacenter to create the event message.

The network-based communication system can send one or more event messages, for example, in an event stream, to each datacenter within the network-based communication system. Each datacenter can receive the event stream and organize the event messages in an event queue. Further, when a datacenter sends out an event message, it may also add the sent event message to its own event queue, along with the other event messages received from other datacenters. In this manner, each datacenter within the network-based communication system has a copy of each event message. Further, each datacenter may organize event messages differently within their event queue.

A datacenter may process the event messages located in its event queue. For example, a datacenter may extract event information from an event message. Even though different datacenters may receive event messages in a different order, each datacenter receives the same event messages. As such, each datacenter processes the event messages.

Each datacenter may update state information upon extracting event information from an event message. In particular, upon processing an event messages in the event queue, the datacenter can update state information associated with each context. An example of a context can be a user account. Accordingly, because each datacenter processes a similar event stream, each datacenter within the network-based communication system will have a similar, but individual, copy of state information for each context.

In some embodiments, the network-based communication system may create a backup or archival copy of the state information for a context, such as a user account. As will be discussed below in additional detail, various factors may be considered in determining the frequency to archive a copy of the state information associated with a user account. Each datacenter may store one or more copies of archived state information for each user account. In some embodiments, datacenters may compare copies of the archived state information between each other to ensure that each event stream is being similarly processed at each datacenter.

A number of benefits are realized when the network-based communication system processes event streams at each datacenter within a network-based communication system. For example, if a first datacenter temporality experiences connectivity issues with the network-based communication system or with a remote service, the remaining datacenters can continue to operate unaffected by the first datacenter outage. Further, the user is unaware that a datacenter outage has occurred because each of the remaining datacenters continue to independently, each having individual copies of user account state information, and each able to provide communication services to users.

In some example embodiments, when the first datacenter comes back online after a connection disruption, one or more of the remaining datacenters can resend event messages to the first datacenter that the first datacenter may have missed. For example, the first datacenter can process its event stream upon returning online such that state information for user accounts stored on the first datacenter are current with the state information for user accounts stored on the other datacenters.

Additionally, and/or alternatively, the first datacenter may receive one or more copies of state information from one or more datacenters. The first datacenter may use these copies to update its locally stored state information for each user account. As one benefit of the one or more embodiments included disclosed herein, the first datacenter can obtain a copy of the state information from any of other datacenter because each of the other datacenters has its own up-to-date copy of the state information for each user account.

In one or more embodiments, the network-based communication system prevents problems arising when a datacenter is cuts off from one or more remote services due to a connection disruption. In particular, because each datacenter has an independent copy of user account state information, a connection loss between one datacenter and a remote service provider does not affect the state information stored on the other datacenters. Further, because state information is locally stored, rather than stored at a remote service provider, the network-based communication system can still provide user account information to users when the remote service provider is temporarily unavailable. As such, network-based communication system can still provide current and accurate state information to users even when a connection failure between a datacenter and a remote service provider occurs.

In one or more embodiments, the network-based communication system can prevent conflicts that could arise within a multiple datacenter network-based communication system. Because the network-based communication system detects each event that is triggered, and sends event messages to each datacenter within the network-based communication system, each event is accounted for at each datacenter. Therefore, events do not conflict with each other, even when two events related to the same user account occur simultaneously at two different datacenters. Further, the network-based communication system can provide additional safeguards from preventing simultaneous events from violating rules established by the network-based communication system.

Furthermore, one or more embodiments of the network-based communication system provide for efficiently use of resources at each datacenter. For example, event messages in an event queue are processed at each datacenter. Each datacenter may process event messages at a rate such that backlog of event messages in the event queue is minimized. To help facilitate this, the network-based communication system may provide additional processing resources to a datacenter when an event queue begins to overload. In this manner, the network-based communication system may dynamically and efficiently allocate additional processing resources when needed, and use the processing resources elsewhere when not needed to process event messages.

Additional advantages and benefits of the network-based communication system will become apparent in view of the below description. In particular, one or more embodiments of the network-based communication system will be described below with reference to one or more figures. In addition, the following definitions of terms will be used to describe one or more features of the network-based communication system.

As used herein, the term “datacenter” refers generally to one or more computing devices that facilitate communication sessions between network devices. In one or more embodiments, a datacenter refers to a facility that houses computer systems and associated components, such as telecommunication and storage systems. For example, one of skill on the art will appreciate that a datacenter may comprise a single computing device that facilitates communication between two or more network devices, or that a datacenter may comprise a building housing computers, servers, and other components facilitating communication for thousands of network devices. Further, a datacenter may be an outbound proxy.

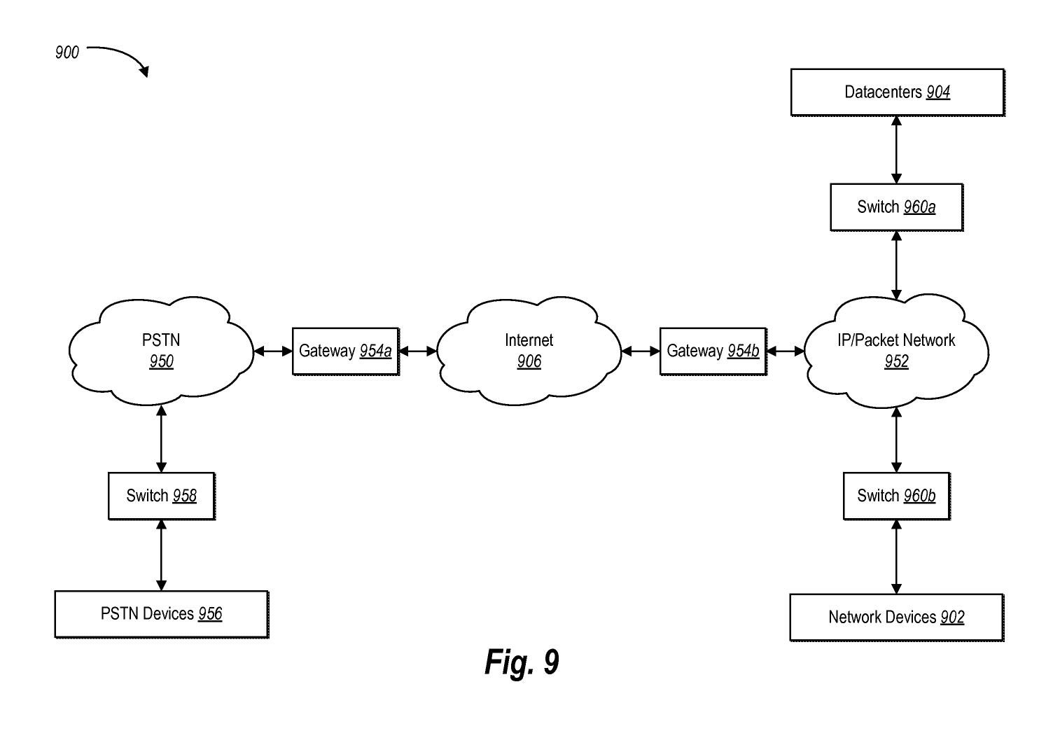

In addition, the term “network device” as used herein refers generally to a computing device that facilitates a communication session. A network device can communicate with a datacenter and other network devices. A variety of network devices may employ VoIP technology, such as personal computers, handheld devices, mobile phones, smartphones, and other electronic access devices. As an example, a network device may be a dedicated VoIP device or soft VoIP device. Dedicated and soft devices are described in additional detail below in connection with FIG. 9.

As used herein, the term “event” refers generally to an occurrence that causes a change (or lack thereof) in state information. An event can be associated with a context, such as a user account. For instance, as used herein, an event can include participating in a communication session; and/or adding, deleting, configuring, or modifying user account information and/or user services. For example, multiple events may be associated with a voicemail service. For instance, an event can include notifying a user of a new voicemail, marking a voicemail as read, deleting or archiving a voicemail. Other examples of events include adding to a user account, changing a user password, or using services that are associated with service fees. In addition, an event can correspond to using services on the network, such as participating in a communication session. An event may also be associated with one or more status updates in a network device or a datacenter. For example, an event may include a confirmation that an event message has been received and/or been processed at a datacenter.

Datacenters may detect events. For example, a datacenter can create an event message upon detecting an event. An event message can include event information associated with the event. In particular, an event message may include event information corresponding to a change in state information associated with a user account. The network-based communication system can send one or more event messages in an event stream, for example, between datacenters.

As used herein, the term “state information” refers generally to the state, status, or condition of a context, such as user account. For example, state information indicates the current state of a user account balance, the status of one or more network devices associated with the user account, the network configuration of a user account (e.g., private branch exchange (PBX) configuration), user and user account passwords, user and user account preferences and settings, call queue information, voicemail information, etc. State information can be associated with a user account, which can have one or more users and can be associated with one or more network devices. Additionally, while the term state information, as used herein, refers to a user account having one or more users, in some embodiments, state information may refer to and be associated with each user within a user account.

As used herein, the term “communication session” refers generally to a communication interaction between one or more network devices that occurs over a network-based communication system. For example a communication session may include voice or video calling, video conferencing, streaming multimedia distribution, instant messaging, presence information sharing, file transferring, faxing over IP, and online gaming. For instance, a session may be part of the session initiation protocol (“SIP”), which is a signaling communications protocol commonly used in network-based communication systems. Likewise, a session may refer to a communication session using other protocols common to IP peer communications.

As used herein, the term “connection” refers generally to an established communication link between at least two computing devices. For instance, two or more network devices connect to, or with, each other when each network device acknowledges the connection with the other network device(s). For example, as further described below, a connection between a network device and a datacenter may occur when the network device is mapped to and registers with the datacenter. A connection can include one or more types of connections, such as a switched circuit connection, a virtual circuit connection, or a network connection. For example, a connection between multiple network devices occurs over a network, such as the Internet, and data sent between the multiple network devices via the connection may employ various network paths.

Although the disclosure discusses one or more example embodiments in reference to VoIP telephone network-based communication systems, it should be understood that the principles, systems, and methods disclosed herein may also be effectively used in other types of packet-based IP communication systems and unified (e.g., real-time) communication systems. For instance, the principles described may be used for sending faxes, text messages, and voice-messages over a network-based communication system.

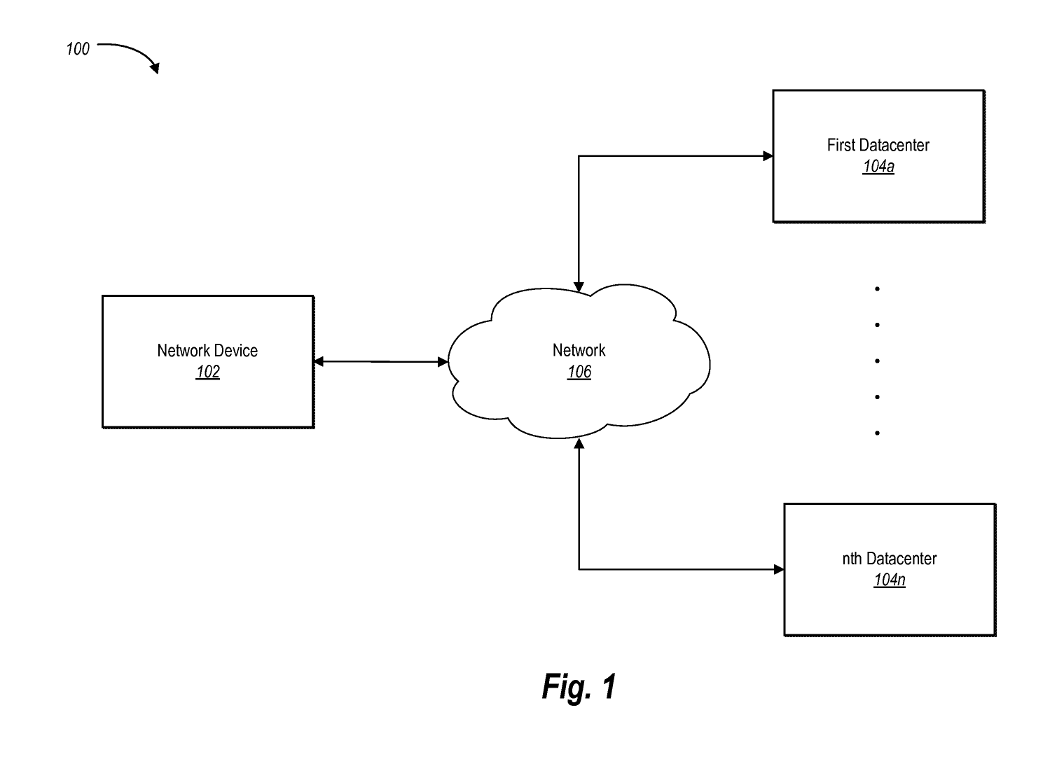

FIG. 1, for example, illustrates a network-based communications system 100 (or simply “system 100”) in accordance with one or more embodiments disclosed herein. As illustrated by FIG. 1, the system 100 may include, but is not limited to, a network device 102, a first datacenter 104a, and an nth datacenter 104n (collectively referred to as “datacenters 104”). As shown, multiple datacenters 104 may be present in the system 100. Similarly, while not illustrated, the system 100 may include multiple network devices (collectively referred to as “network devices 102”). For example, the system 100 may include almost any number of network devices 102 and/or datacenters 104.

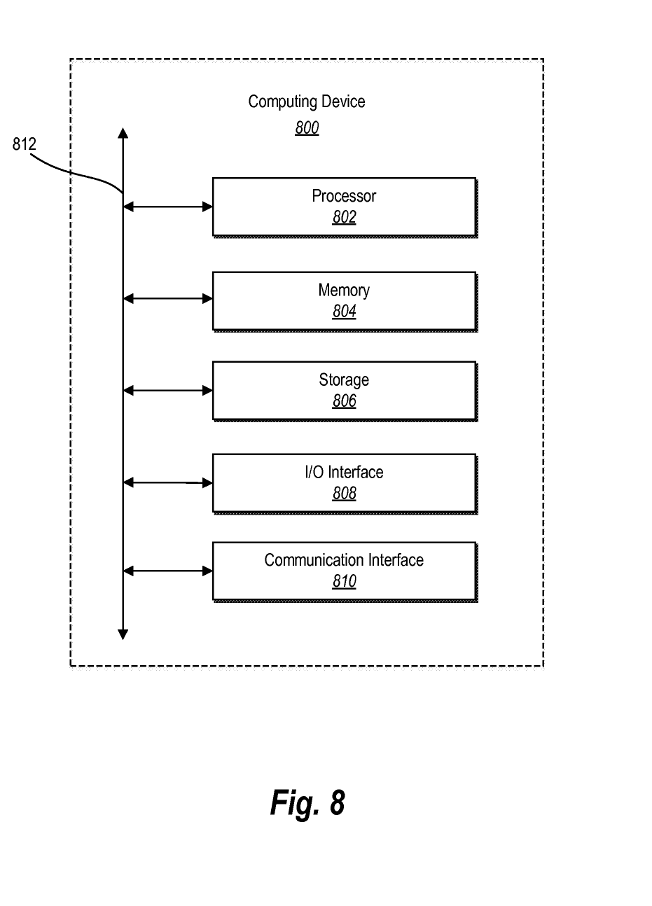

The network device 102 and the datacenters 104 are connected via a network 106. In some configurations, the network 106 may be the Internet, an intranet, a private network, or another type of computer network. The network 106 may be a combination of Internet and intranet networks. Additional details regarding the network will be discussed below with respect to FIGS. 8 and 9.

As will be explained in additional detail below, a network device 102 can connect to multiple datacenters 104. In addition, datacenters 104 can connect to each other. For example, the first datacenter 104a may detect an event occurring on a network device 102 triggered by a user action. In response, the first datacenter 104a may create an event message and send the event message to other datacenters 104 in the system 100. Each datacenter, including the first datacenter 104a, may process an event message and update state information associated with the user account.

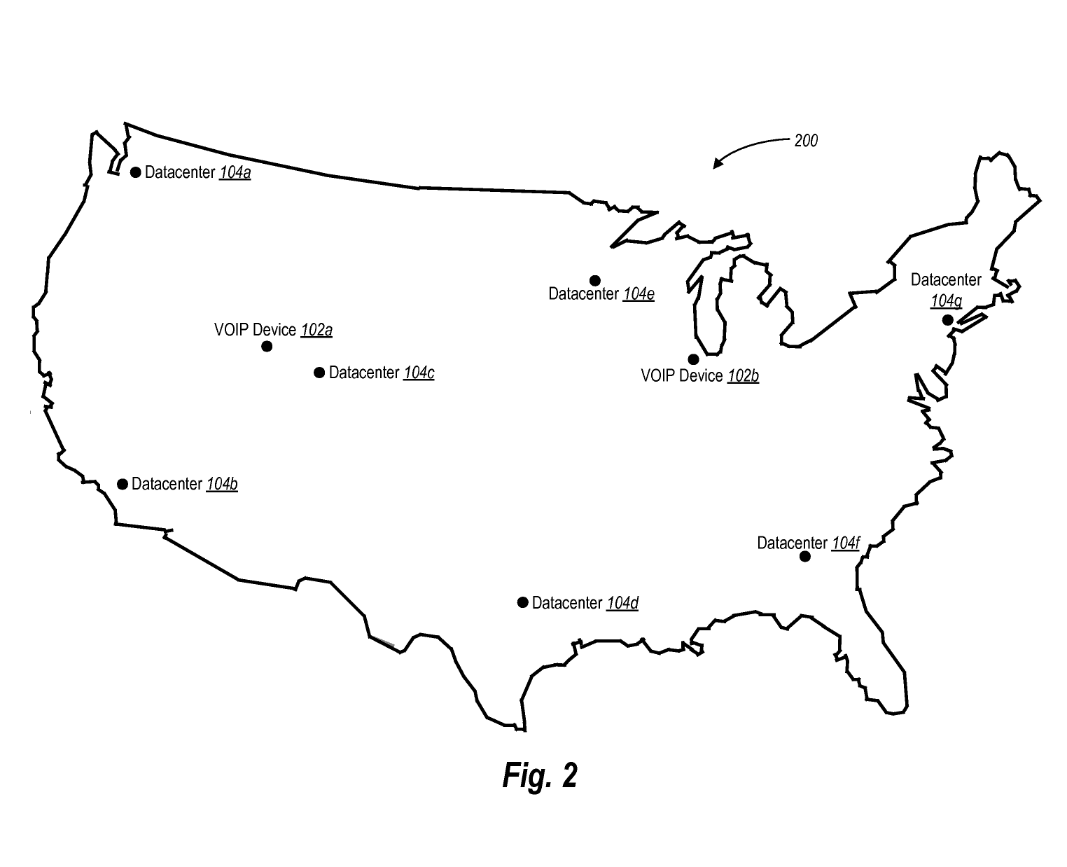

FIG. 2 illustrates a map schematic 200 where the network-based communication system 100 of FIG. 1 may be utilized according to principles described herein. In particular, FIG. 2 illustrates a map 200 of the United States where the system 100 may be employed. One of skill in the art will note, that while FIG. 2 illustrates a map of the United States, the embodiments, configurations, and systems disclosed herein are not limited to any particular geographic regions. For example, the system 100 may operate across a number of countries, regions, and continental boundaries. For instance, VoIP communication may utilize communication devices located in space.

As illustrated in FIG. 2, the map 200 includes two network devices 102a-b and seven datacenters 104a-g. The datacenters 104 may be geographically distributed throughout the map 200. For example, FIG. 2 illustrates a datacenter 104 in Seattle, Los Angeles, Denver, Dallas, Minneapolis, Atlanta, and New York City. One of skill in the will appreciate that the datacenters 104 are not limited to any particular geographic locations. Similarly, the network devices 102 are also not location specific.

For simplicity, only two network devices 102 are illustrated. In particular, the first network device 102a is located in Salt Lake City, and the second network device 102b is located in Chicago. While not illustrated, the map 100 may include a number of other network devices 102. For example, multiple network devices 102 may be located in the same location as well as located throughout various locations.

As described above, network devices 102 may map to and register with multiple datacenters 104 at the same time. For example, the first network device 102a maps to the Los Angeles datacenter 104b. Further, the first network device 102a also maps to the Denver datacenter 104c while maintaining the mapping with the Los Angeles datacenter 104b.

After mapping to multiple datacenters 104, the first network device 102a may register with and connect to each of the datacenters 104. For example, the first network device 102a may register with and connect to the Los Angeles datacenter. The first network device 202a may also register with and connect to the Denver datacenter 104c.

While the first network device 102a is connected to the Los Angeles datacenter 104b and the Denver datacenter 104c, the first network device 102a may use services provided by either datacenter 104. For example, the first network device 102a may particulate in a communication session via the Los Angeles datacenter 104b. In addition, the first network device 102a may access voicemail services via the Denver datacenter 104c.

If the connection between a network device 102 and one of the datacenters 104 fails, the network device 102 can use on the connection with the other datacenter 104 to access the system 100. For example, the second network device 102b connects to the Minneapolis datacenter 104e and the New York City datacenter 104g. The second network device 102b may provide access to the system 100 via the Minneapolis datacenter 104e connection. If the Minneapolis datacenter 104e connection, however, fails while the user is accessing the system 100, the second network device 102b may seamlessly switch over to the New York City datacenter 104g connection. The user does not recognize that he or she has changed datacenter connections when the changeover occurs due to the seamless nature of the changeover.

In addition, the network device 102 may switch from one datacenter connection to another datacenter connection when one datacenter connection quality degrades beyond a threshold level. Further, because each datacenters 104 has a copy of the user account state information, any datacenter 104 can provide the user with up-to-date access to user account information and/or related services provided the system 100. For example, each datacenter 104 can provide voicemail information to a user because voicemail information is stored each datacenter 304, in association with the user's state information, rather than being stored remotely on a remote service provider.

In one or more embodiments, a datacenter 104 may detect an event triggered at the network device 102. For example, if the first network device 102a is connected to the system 100 via the Denver datacenter 104c, the Denver datacenter 104c may detect an event that occurs at the first network device 102a. For instance, a user may perform an action that triggers an event on the first network device 102a, such as starting a communication session, changing a user setting, accessing voicemail, etc. In another instance, the Minneapolis datacenter 104e may trigger an event detected by the Denver datacenter 104c.

The Denver datacenter 104c can create an event message based on the detected event and send the event message to the other datacenters 104 in the system 100. For example, the Denver datacenter 104c may send the event message to the Seattle datacenter 104a, Los Angeles datacenter 104b, Dallas datacenter 104d, Minneapolis datacenter 104e, Atlanta datacenter 104f, and New York City datacenter 104g. Each datacenter 104 that receives the event message can add the event message to an event queue associated with the datacenter 104. In addition, the Denver datacenter 104c can add the event message to its event queue.

In addition, the Dallas datacenter 104d may detect a second event triggered at the second network device 102b. The Dallas datacenter 104d may create a second event message and send the second event message to the Seattle datacenter 104a, Los Angeles datacenter 104b, Denver datacenter 104c, Minneapolis datacenter 104e, Atlanta datacenter 104f, and New York City datacenter 104g. Each datacenter 104 that receives the event message can add the event message to an event queue along with the event message received from the Denver datacenter 104c.

Each datacenter 104 may process the event messages, for example, by extracting the event information in each event message. Further, each datacenter 104 may update state information for a context (e.g., user account) based on the event information. In some embodiments, the first event message and second event message may be associated with the same context. Thus, regardless of the order that each datacenters 104 processes the event messages, the state information of the context associated with the event messages will be the same on each datacenter 104 after each datacenter 104 process both event messages. In other embodiments, the two event messages may be associated with different contexts. Accordingly, when a user accesses the system 100 via any datacenter 104, that datacenter 104 will have up-to-date state information to provide to a user.

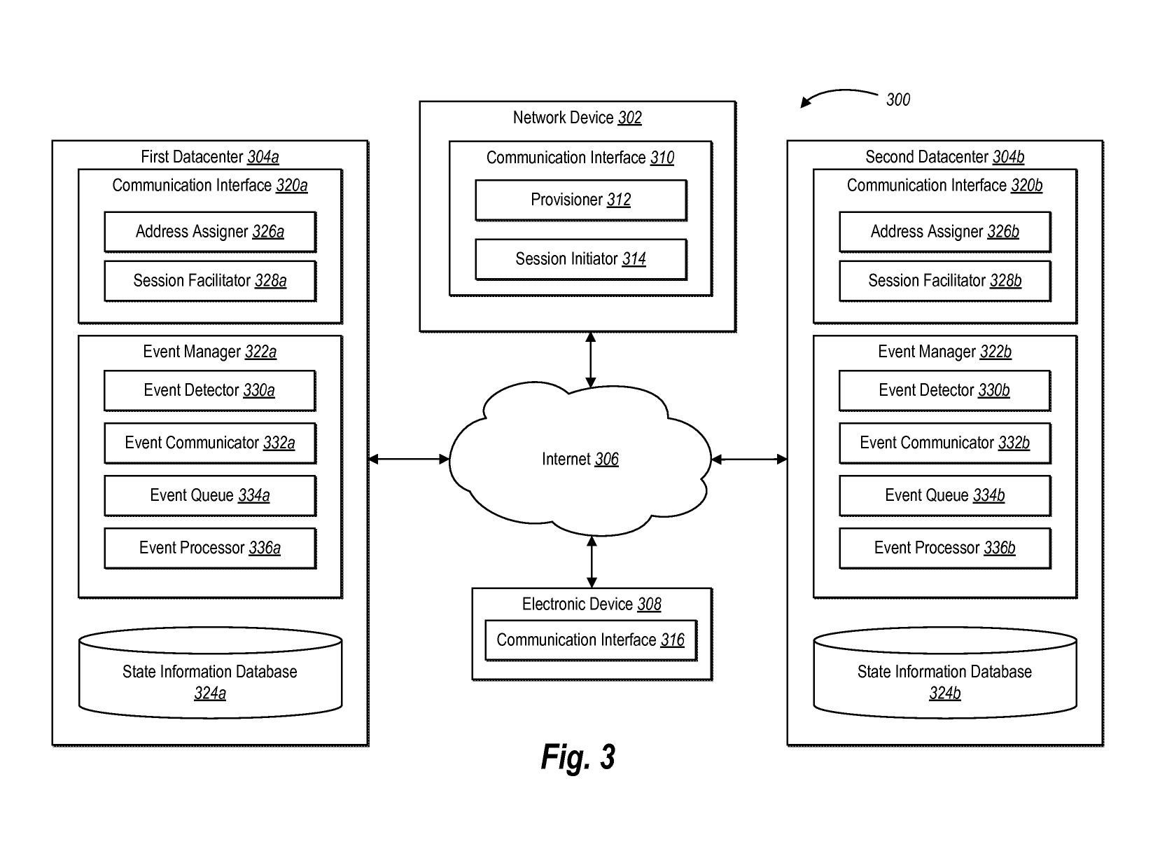

FIG. 3 illustrates an exemplary network-based VoIP communication system 300 (hereafter “VoIP system 300”) according to principles described herein. As illustrated, the system 300 includes a network device 302, a first datacenter 304a, and a second datacenter 304b. In some embodiments, the system also includes an electronic device 308. For example, VoIP system 300 may be one exemplary configuration of the system 100 described in connection with FIG. 1. For instance, the network device 302 may be one exemplary embodiment of the network device 102. Likewise, the first datacenter 304a and the second datacenter 304b may be exemplary embodiments of the datacenters 104a-n described in connection with FIG. 1. Although the VoIP system 300 is described as having a first datacenter 304a and a second datacenter 304b (collectively “datacenters 304”) for ease of explanation, the principles described with respect to FIG. 3 can be implemented within a VoIP system 300 having any number of network devices 302, datacenters 304, and electronic devices 308.

The network device 302 and/or the electronic device 308 may connect to the datacenters 304 via the Internet 306. In some configurations, the network device 302 and/or the electronic device 308 may be directly connected to one or more datacenters 304, or via a private network. In addition, the network device 302 and/or the electronic device 308 may securely connect to a datacenter 304 via a secure connection, for example, using secure sockets layer (“SSL”) protocol, or another cryptographic protocol.

In some configurations, the network device 302 may be a VoIP device. The network device 302 may allow a user to communicate with other users. For instance, the network device 302 may facilitate voice and data communication sessions between users. The network device 302 may also allow a user to modify preferences and access user account settings via a connection with one or more datacenters 304. In addition, as described above, users may communicate with their peers using other forms of communication provided by network device 302, such as a videoconference.

As illustrated, the network device 302 includes a communication interface 310. In addition, the network device 302 may also include input and output audio/video functionality as described below in connection with FIG. 8. For example, as described in additional detail below, the network device 302 may be a dedicated device, or a soft device, such as a dedicated VoIP device.

As illustrated, the communication interface 310 may include a provisioner 312, and a session initiator 314. In general, the provisioner 312 maps and registers the network device 302 to one or more datacenters 304. The session initiator 314 facilitates communications between users via the network device 302.

One of skill in the art should note that components 312-314 may be independent from the communication interface 310. For example, the session initiator 314 may be a separate module on the network device 302. In addition, one or more of the above listed components included in the communication interface 310 may be located outside of the network device 302. Further, each of the components 312-314 of VoIP system 300 may be in communication with one another using any suitable communication technologies. It will be recognized that although components 312-314 are shown to be separate in FIG. 3, any of components 312-314 may be combined into fewer components, such as into a single component, or divided into more components as may serve a particular embodiment. In addition, components 312-314 may be located on, or implemented by, one or more network devices, such as those described below in relation to FIG. 8. Alternatively, portions of components 312-314 can be located on a network device 302, while other portions are located on one or more datacenters 304.

Components 310-314 can comprise software, hardware, or both. For example, components 310-314 can comprise one or more instructions stored on a non-transitory computer-readable storage medium and executable by processors of one or more computing devices. When executed by the one or more processors, the computer-executable instructions of VoIP system 300 can cause a network device and/or datacenter to perform the methods described herein. Alternatively, components 310-314 can comprise hardware, such as a special purpose processing device to perform a certain function or group of functions. Additionally or alternatively, components 310-314 can comprise a combination of computer-executable instructions and hardware.

As mention above, the communication interface 310 can send and receive data. For example, the communication interface 310 may transmit or receive queries, requests, acknowledgements, signals, indications, etc., between the network device 302 and one or more datacenters 304. For instance, the communication interface 310 may facilitate connecting to the first datacenter 304a and accessing services provided by the VoIP system 300.

In one or more embodiments, the provisioner 312 connects the network device 302 to one more datacenters 304. For example, the provisioner 312 may facilitate the connection between the network device 302 and the first datacenter 304a. In addition, or in the alternative, the provisioner 312 may facilitate the connection between the network device 302 and the second datacenter 304b. The network device 302 may communicate with other network devices 302 and/or other electronic devices 308 via the VoIP system 300 once connected with the datacenter 304.

As part of the provisioning process, the provisioner 312 may request a network device address from a datacenter 304 for the network device 302. For example, the network device address may the address where the network device 302 can be reached by other network devices on the VoIP system 300. As described below, the address assigner 326 on a datacenter 304 can assign a network device address to the network device 302.

The session initiator 314 can facilitate communications between users via the network device 302. For example, the session initiator 314 may initiate audio, video, and other types of communication sessions between users. The session initiator 314 may employ protocol, such as SIP, in facilitating communication sessions between users. As described in further detail below, the session initiator 314 may communicate with the session facilitator 328 on a datacenter 304 to which a network device 302 connects.

A user may use the network device 302 to gain access to the VoIP system 300. Because network devices 302 are connected to datacenters 304, when a user performs an action using a network device 302, the user action may trigger an event that a datacenter 304 detects. For example, if the network device 302 is connected to the second datacenter 304b and a user using the network device 302 performs an action that triggers an event, the second datacenter 304b can detect that the event and notify other datacenters 304 of the event. Additional detail corresponding to a datacenter 304 detecting an event triggered by user action is given below.

As illustrated in FIG. 3, the VoIP system 300 may include an electronic device 308. For example, the electronic device 308 may be a personal computer, laptop, or mobile device. Additional examples of electronic devices are described below in connection with FIG. 8. The electronic device 308 includes a communication interface 316. The communication interface 320 may send and receive communications between the electronic device 308 and one or more datacenters 304. For instance, the communication interface 316 can receive information relating to state information for a context, such as a user account.

In particular, a user may use the electronic device 308 to lookup, add, deleted, or modify user account information. For example, a user can add funds to a user account using the electronic device 308. In addition, the user can use the electronic device 308 to check a voicemail, change a password, add a service, or terminate service. When a user uses the electronic device 308 to access information or services provided by the VoIP system 300, a datacenter 304 may detect an event and notify other datacenters 304 of the event via an event message.

As illustrated in FIG. 3, the VoIP system 300 may include a first datacenter 304a and a second datacenter 304b. The first datacenter 304a includes a communication interface 320a, an event manager 322a, and a state information database 324a. Similarly, the second datacenter 304b includes a communication interface 320b, an event manager 322b, and a state information database 324b.

For convenience, the datacenters 304 will be described with reference to the first datacenter 304a. The second datacenter 304b, however, may be described similarly to the first datacenter 304a described below. For example, the communication interface 320b, event manager 322b, and state information database 324b of the second datacenter 304b may perform similar operations as the communication interface 320a, event manager 322a, and state information database 324a of the first datacenter 304a.

As illustrated, the communication interface 320a on the first datacenter 304a may include an address assigner 324a and a session facilitator 326a. The event manager 322a may include an event detector 330a, an event communicator 332a, an event queue 334a, and an event processor 336a. Each of the components 326a-336a of VoIP system 300 may be in communication with one another using any suitable communication technologies. It will be recognized that although components 326a-336a are shown to be separate in FIG. 3, any of components 326a-336a may be combined into fewer components, such as into a single component, or divided into more components as may serve a particular embodiment. In addition, components 326a-336a may be located on, or implemented by, one or more network devices, such as those described below in relation to FIG. 8. Alternatively, portions of components 326a-336a can be located on a network device 302, while other portions are located on one or more datacenters 304.

Components 320a-336a can comprise software, hardware, or both. For example, components 320a-336a can comprise one or more instructions stored on a non-transitory computer-readable storage medium and executable by processors of one or more computing devices. When executed by the one or more processors, the computer-executable instructions of VoIP system 300 can cause a network device and/or datacenter to perform the methods described herein. Alternatively, components 320a-336a can comprise hardware, such as a special purpose processing device to perform a certain function or group of functions. Additionally or alternatively, components 320a-336a can comprise a combination of computer-executable instructions and hardware.

The communication interface 320a can send and receive data. For example, the communication interface 320a may send or receive queries, requests, acknowledgements, signals, indications, etc., between the network device 302 and the first datacenter 304a. For instance, the communication interface 320a can facilitate a connected between the network device 302 and the first datacenter 304a. The communication interface 320a can also provide services to a network device 302 connected to the first datacenter 304a.

As mentioned above, the communication interface 320a includes an address assigner 324a and a session facilitator 326a. The address assigner 326a can assign a network device address to the network device 302 when the network device 302 first connects to the datacenter 304. For example, the address assigner 326a may provide a network device address to the network device 302 that includes a network device's network device identifier associated with the network device 302. For instances, the network device address may be tied to the MAC (media access control) address of the network device 302. Alternatively, the network device address may be in the form of <network device identifier>@VoIP-System.net. In addition, when the address assigner 326a provides an address to the network device 302, the address assigner 326a may also register the network device 302 with the VoIP system.

In particular, in one or more system 300 configurations, the address assigning process may be in accordance with session protocol, such as SIP. SIP communications exhibit a SIP uniform resource identifier (“URI” or “SIP URI”) that identifies each participant of a SIP session. In one embodiment, the SIP URI comprises a username and a domain in the form of user@domain. Further, the identifier “SIP” may precede the SIP address to indicate that the communication is a SIP communication. For instance, the SIP URI may take the form of SIP:user@domain.net or SIP:user@domain.net:port. In addition, the SIP URI may include a globally-routable domain. For example, one network device 302 is registered with SIP URI userA@domain.com, while a second device is registered with the SIP URI userB@domain.com. In some configurations, a SIP URI may be registered with multiple network devices.

The session facilitator 328a may facilitate a communication session between the two users. In particular, the session facilitator 328a may provide communication services to a user using a network device 302. For instance, the session facilitator 328a may establish a media bridge connection between the network devices 302 of the two users. As described above, the session facilitator 328a may provide communication services to a session initiator 312 on a network device 302.

As illustrated, the event manager 322a includes an event detector 330a, an event communicator 332a, an event queue 334a, and an event processor 336a. In one or more embodiments, the event detector 330a detects events that occur at the first datacenter 304a. For example, a user may perform an action detected by the first datacenter 304a using a network device 302 or an electronic device 308. For instance, a user, connected to the first datacenter 304a via the electronic device 308 may add funds to their user account. For example, the user may add money to their user account using a smartphone.

The first datacenter 304a can detect the event triggered by the user action. For example, the first datacenter 304a can detect a user marking a voicemail message as read or a user changing a password. In some instance, the event detector 330a may detect an event triggered by the VoIP system 300.

Upon the first datacenter 304a detecting an event, the event detector 330a can create an event message upon detecting an event. As described above, an event message may include information about an event, such as the type of event, the user account associated with the event, the time the event was detected, where the event occurred, etc. In some embodiments, the event detector 330a may create a new event message for each event it detects.

In other embodiments, the event detector 330a may group multiple detected events into an event message. For example, an event messages may include multiple events that occur within a predetermined time period, for instance, when each event is associated with a single user account. To illustrate, a user may modify multiple user account settings, such as their contact information and their password. Each change may trigger a separate event at the first datacenter 304a. However, while the event detector 330a may detect each of these events separately, the event detector 330a may group the multiple detected events in to a single event message.

The event communicator 332a may send event messages to other datacenters 304 within the VoIP system 300. In general, an event communicator 332 will send a copy of each event message to every datacenter 304 within the VoIP system, including the datacenter 304 where the event communicator 332 is located. For example, the event communicator 332a on the first datacenter 304a may send event messages to both the first datacenter 304a and the second datacenter 304b. When the event communicator 332a sends a message to the first datacenter 304a, the event communicator 332a can send the event message to an event queue 334a associated with the first datacenter 304a. In some example embodiments, the event communicator 332a can sent the event message to one or a group of event queues depending on based on the priority of the event message.

In addition, the event communicator 332a may receive event messages from other datacenters 304 within the VoIP systems 300. For example, the second datacenter 304b can send an event message to the first datacenter 304a. When the event communicator 332a on the first datacenter 304a receives event messages, the event communicator 332a can send the event message to the event queue 334a.

In one or more embodiments, the event queue 334a organizes event messages. In particular, the event queue 334a may temporarily store event messages as event messages enter and exits the event queue 334a. In some embodiments, the event queue 334a may order the event messages within the event queue 334a before the event messages leave the event queue 334a to be processed. The event queue 334a, for example, may order event messages in the order they were received at the event queue 334a, based on the time the event message was created, or based on the time the event was detected.

In some embodiments, the event queue 334a may order event messages based on a priority level. For instance, the event queue 334a can prioritize event messages according to the type of event identified in each event message. For example, the event queue 334a may prioritize event messages associated with financial transaction over event message associated with call queues.

In one or more embodiments, the event manager 322a can include multiple event queues 334. One event queue can be prioritized above another event queue. For example, event messages in a first event queue can process event messages before processing event messages in a second event queue. In addition, an event queue can send one or more event messages to another event queue when promoting or demoting the processing priority of an event message. In some example embodiments, if too many event messages are put into an event queue, one or more event messages can be rebalanced amount multiple event queues at a datacenter 304.

In one or more embodiments, multiple event queues 334 can correspond to multiple types of events. For example, system initiated events can be placed in an event queue for system event messages while user initiated events can be stored in another event queue associated with user event messages. For instance, the event communicator 332a can place event messages associated with creating a new user account in a system event queue 334a.

In addition, in some example embodiments, a particular event queue 334a, unique to the VoIP system 300, may be located on a specific datacenter 304. For example, the VoIP system 300 can detect particular events that require a higher level of processing rights, which may only be placed in a particular event queue at a specific datacenter 304. For example, in the case of processing an event message that creates a new user account, the VoIP system 300 can require that the particular event message associated with creating the new account be placed in a particular event queue 334a located on the first datacenter 304a. Further, when other datacenters 304 detect a particular event that requires additional rights to processes, such as creating a new user account, the other datacenters 304 can forward the event message to the datacenter 304 that has the particular event queue 334.

Often processing a particular event message leads to the creation of multiple additional event messages. For instance, when the new user account event message is processed at the first datacenter 304a, the first datacenter 304a can create addition event messages, such as event messages regarding newly created account name, user settings and preferences, and the user account balance, etc. Once the datacenter 304 processes the particular event message from the particular event queue 334a, as described below, the datacenter 304 can send the additional event messages to the other datacenters 304. For example, the first datacenter 304a can send additionally created event messages corresponding to a new user's account name, preferences, balance, etc., to the other datacenters 304 in the VoIP system 300. Accordingly, by requiring, for example, that particular event messages be placed in a particular event queue 334a, the VoIP system 300 can prevent duplication of conflicting critical event messages while still providing non-realtime information to each datacenter 304 in the VoIP system 300.

In one or more example embodiments, the event processor 336a may process one or more event messages. For example, the event processor 336a can receive one or more event messages from the event queue 334a. Upon receiving an event message, the event processor 336a can process the event message.

The event processor 336a processes each event detected by one of the datacenter 304 within the VoIP system 300. Accordingly, because each event that occurs in the VoIP system 300 is sent to the first datacenter 304a in an event stream, the event processor 336a on the first datacenter 304a processes each event that occurs in the VoIP system 300. In this manner, the event processor 336a on the first datacenter 304a processes each event message that is triggered in the VoIP system 300.

In one or more embodiments, as describe above, the event processor 336a can process events from one or more event queue 334a. For example, the event processor 336a can process event messages in a higher prioritized event queue 334a before processing event messages in a lower prioritized event queue 334a. Alternatively, the event processor 336a can process events from multiple event queue 334a in parallel.

In one or more embodiments, the event processor 336a can extract event information from an event message. For example, the event processor 336a extracts event information from the event message, such as the type of event, the user account associated with the event, the time of the event, etc. The event information can provide updated information relating to the state of a user account.

In addition, the event processor 336a can update state information associated with a user account. For instance, the event processor 336a can use to event information to update state information stored in the state information database 324. In this manner, as the event processor 336a processes each event message, the event processor 336a may update state information associated with each available connection.

Further, as described above, because the event processor 336a on the first datacenter 304a processes each event that occurs within the VoIP system 300, the state information stored at the first datacenter 304a reflects all events that occur in the VoIP system 300. In other words, the first datacenter's 304a copy of state information for each is kept up-to-date as each event is processed, even if the state information is updated in non-realtime.

In some example embodiments, the event processor 336a may increase or decrease processing capabilities. For example, the event processor 336a may track the rate at which event messages are being added to the queue 334a and increase or decrease processing capabilities to accommodate incoming event messages. Additionally, or alternatively, the first datacenter 304a may identify when the number of event messages in an event queue 334a surpasses a predetermined amount. When the number of event messages in the event queue 334a equal or surpasses a predetermined amount, the event processor 336a may increase the processing capabilities of the event queue 334a until the number of event messages drops below a predetermined level and/or slows below a specified rate.

In some embodiments, the event processor 336a may increase processing by adding additional services or resources on the first datacenter 304a to process event messages. For example, the event processor 336a may notify the event manager 322a that additional processing resources are needed, and the event manager 322a can allocate additional processing resources to the event manager 322a until the additional processing resources are no longer needed. When less processing is required, the event manager 322a may use the additional services or resources in other areas on the first datacenter 304a. As such, the event processor 336a may efficiently allocate processing resources between components and services on the first datacenter 304a.

In some embodiments, the event processor 336a may archive a copy of state information for one or more user accounts. For instance, the event processor 336a may archive copies of the state information at regular intervals, such as once each minute, hour, or day, every x number of processed events, etc. The event processor 336a can store the archived copies of the state information in the state information database 324.

In one or more embodiments, the first datacenter 304a can send and/or receive copies of state information for one or more user accounts with other datacenters 304 on the VoIP system 300. For example, the first datacenter 304a may receive a copy of state information for a first user account from the second datacenter 304b. The first datacenter 304a may compare and/or synchronize the two copies of state information together to verify accuracy.

In some embodiments, if the copies of state information on the first datacenter 304a do not match copies of state information on other datacenters 304, the first datacenter 304a may request copies of event messages processed at the second datacenter 304b. In this manner, the first datacenter 304a can identify any event message messages that the event processor 336a did not process. In addition, if the copies of state information do not match, the first datacenter 304a may request copies of state information from other datacenters 304 within the VoIP system 300. The event processor 336a on the first datacenter 304a can identify which copies of state information is correct, for example, by comparing each of the copies of state information for a user account between each datacenter 304 in the VoIP system, because each datacenter 304 has an up-to-date copy of state information for each user account.

For example, when comparing the copies of state information for a user account, the event processor 336a can compare event message identifiers included in state information. For example, when the event processor 336a initially updates the updated state information from event information associated with an event message, the event processor 336a can also include the event message identifiers in the state information update. In this manner, the event processor 336a can compare similar copies of state information between datacenters 304, and when two copies do not match, the event processor 336a may determine if one of the copies of state information missed processing an event message, or if one of the copies included duplicative processing of an event message. The event processor 336a may also compare copies of the state information by comparing hashes of the copies to determine if the copies match.

In one or more embodiments, the event processor 336a may include the number of event messages that have been processed when updating the state information for a user account. For example, each time the event processor 336a processes an event message associated with a user account, the event processor 336a may increment a counter associated with the user account. The event processor 336a can use the counter when comparing copies of state information between datacenters 304. The counter can be reset when the event processor 336a creates an archive of the state information. For example, the event processor 336a can create an archive of the state information at midnight each day, upon which an event processed counted is reset.

Additionally, or alternatively, the event processor 336a may update the state information with a timestamp. The timestamp can include the time the state information was last updated and/or the creation time of the last event message that was processed by the event processor 336a.

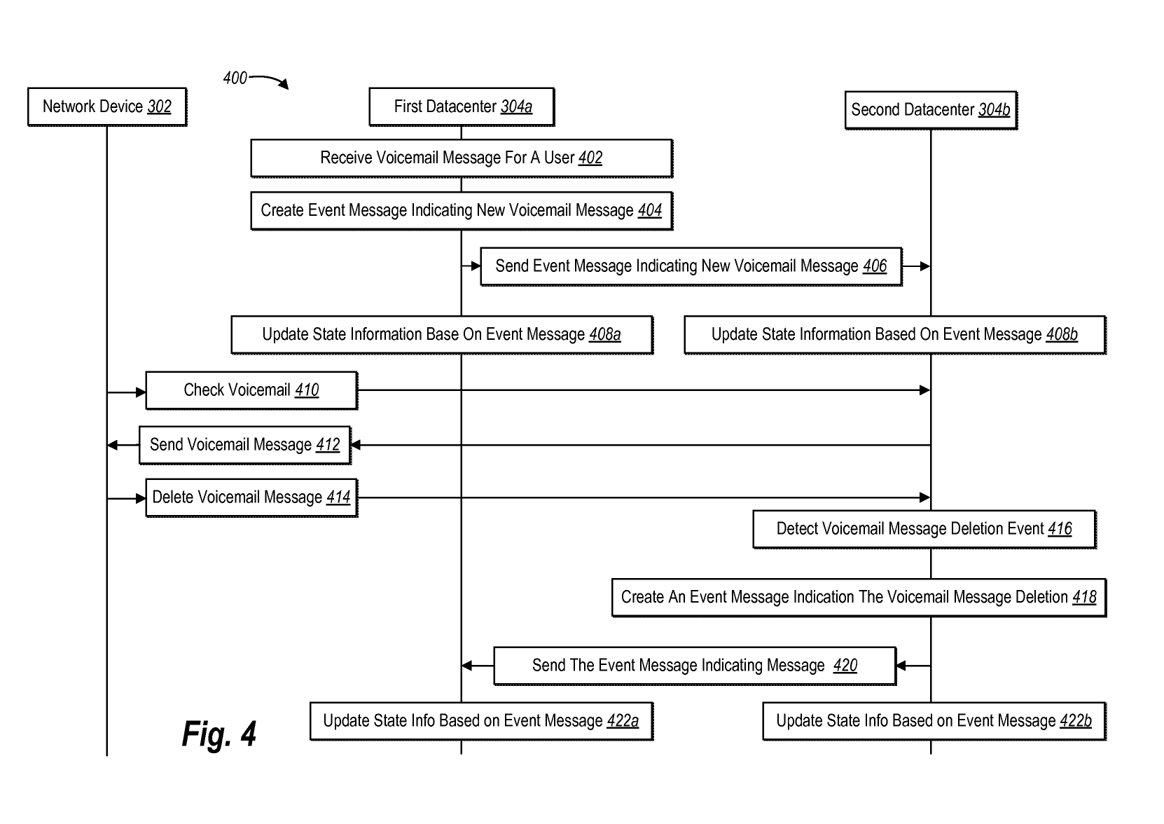

FIG. 4 illustrates a sequence-flow method 400 illustrating interactions between the network device 302, the first datacenter 304a, and the second datacenter 304b in the VoIP communication system 300 of FIG. 3 in accordance with one or more embodiments disclosed herein. In particular, the method 400 of FIG. 4 illustrates an example method of detecting a voicemail event at one datacenter 304 and updating state information at each datacenter 304 based on the detected event.

To illustrate, the first datacenter 304a may detect an event. In particular, in step 402, the first datacenter 304a may receive a voicemail message for a user associated with a user account. For example, a caller may have left a voicemail message for the user. The first datacenter 304a may record the voicemail message along with information associated with the voicemail message, such as the caller's number, the time the voicemail message was created, message urgency, an identification number for the voicemail message, etc. The first datacenter 304a may also recognize the presence of a new voicemail message as an event. As described above, the event detector 330a on the first datacenter 304a can detect the event.

Step 404 may include the first datacenter 304a creating an event message indicating a new voicemail message. The event message may include the stored location of the voicemail message, if the voicemail message stored remotely. In addition, the event message may include information about the voicemail message as well as the status of the voicemail message, such as new, read, archived, deleted, etc. As described above, the event detector 330a on the first datacenter 304a can create the event message.

Step 406 may include the first datacenter 304a sending the event message indicating the new voicemail message to the second datacenter 304b. In addition, the first datacenter 304a may send the event message to other datacenters 304 within the VoIP system 300. For example, the event communicator 332a on the first datacenter 304a may send the event message to the other datacenters 304. In this manner, each datacenter 304 within the VoIP system 300 receives the event message, including the datacenter 304 that detected and sent out the event message. As described above, the event communicator 332a on the first datacenter 304a can create the event message. In addition, each datacenter 304 that receives the event message may organize the event message in an event queue for processing.

Each datacenter 304 may process the event message indicating the new voicemail message. For example, step 408 may include updating state information for the user account associated with the user to reflect the new voicemail message. For example, an event processor 336 can process the event message and update state information associated with a context user account at each datacenter 304.

In particular, step 408a may include the first datacenter 304a updating the state information to indicate the new voicemail message for the user account at the first datacenter 304a. In step, 408b, the second datacenter 304b can update the state information to indicate the new voicemail message for the user account at the second datacenter 304b. In this manner, each datacenter 304 within the VoIP system 300 can maintain an individual copy of state information reflecting each event that occurs in the VoIP system 300 for each context.

Step 410 may include the user checking their voicemail using the network device 302. In particular, the network device 302 can send a request to the second datacenter 304b inquiring about the new voicemail message. In response, the second datacenter 304b, step 412 can include sending the voicemail message to the user via the network device 302. In some embodiments, the user may access voicemail services via a electronic device 308 rather than via the network device 302.

As illustrated in step 410, the network device 302 sends the voicemail request to the second datacenter 304b. However, the network device 302 could equally send the request to the first datacenter 304a. Because both the first datacenter 304a and the second datacenter 304b have updated state information reflecting the new voicemail message, either datacenter 304 could process the user's request to check the new voicemail message. Further, the user generally is unaware which datacenter 304 the network device 302 is communication with so long as the user is able to access services provided my the VoIP system 300.

Step 414 may include the user deleting the voicemail message. For example, after listening to the voicemail message using the network device 302, the user may instruct the second datacenter 304b, via the network device 302, to archive, delete, skip, save, replay, etc. the voicemail message. For instance, the user can give commands via the voice and/or numeric tones, to the second datacenter 304b instructing the second datacenter 304b to delete the voicemail message.

The second datacenter 304b can detect an event triggered by user action. In particular, in step 416, the second datacenter 304b may detect the user's instruction to delete the voicemail message as an event. For example, when the user instructs the second datacenter 304b to delete the voicemail message, the second datacenter 304b may detect this event as a message deletion event. For example, the event detector 330b on the second datacenter 304b may detect the voicemail message deletion event.

Step 418 can include creating an event message indicating the voicemail message deletion. For example, the event detector 330b on the second datacenter 304b may create the event message indicating the voicemail message deletion. As described above, the event message may include other information, such as the time the second datacenter 304b detected and/or created the event message, the priority of the event message, the user account associated with the event, etc.

Step 420 can include the second datacenter 304b sending the event message to the other datacenters 304 within the VoIP system 300. In particular, step 420 can include the second datacenter 304b sending the event message indicating the voicemail message deletion to the first datacenter 304a. For example, the event communicator 332b on the second datacenter 304b can send the event message to the first datacenter 304a.

Step 422 may include processing the event message indicating the event message. For example, step 422 may include updating state information to reflect the user's request to delete the voicemail message as indicated in the event message. For example, an event processor 336 can process the event message and update state information associated with a user account at each datacenter 304.

In particular, step 422a can include the first datacenter 304a updating the state information to indicate the voicemail deletion at the first datacenter 304a. Similarly, in step, 422b, the second datacenter 304b can update the state information at the second datacenter 304b to indicate the voicemail deletion. Accordingly, each datacenter 304 within the VoIP system 300 continues to maintain individual copies of state information for each context.

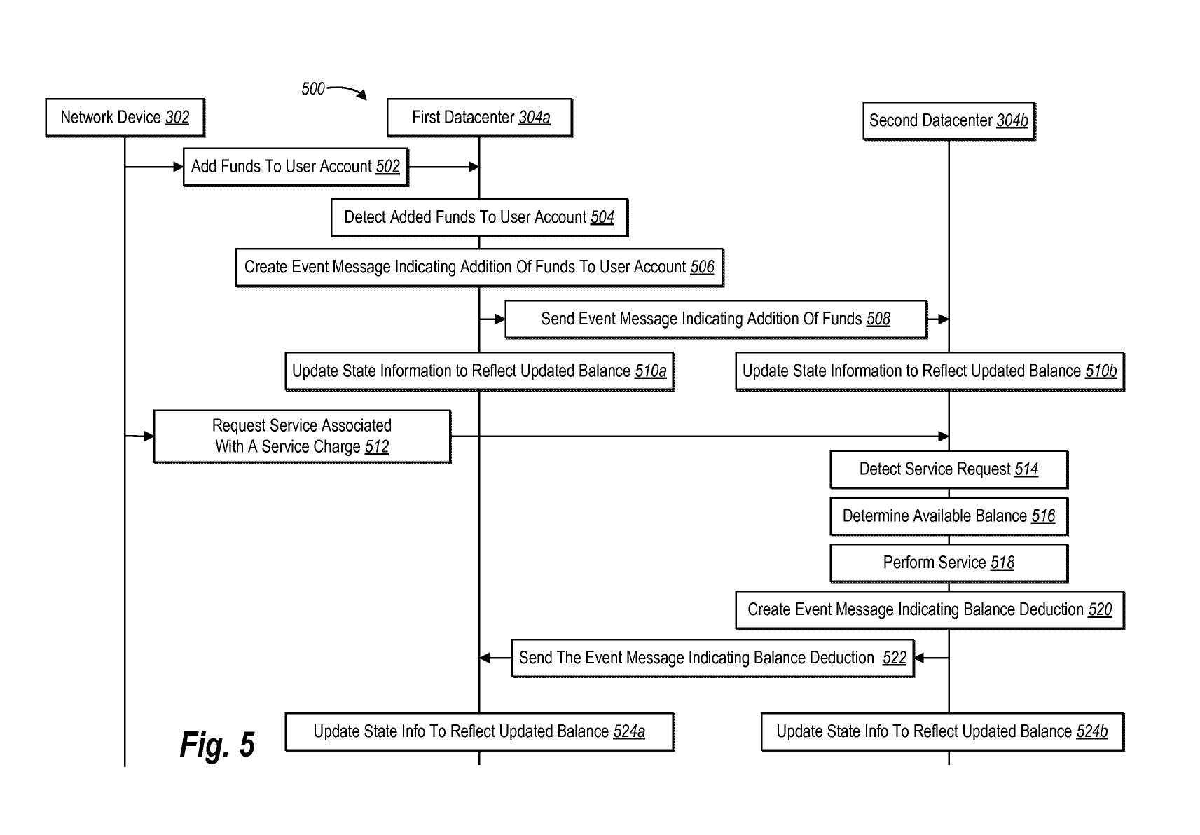

FIG. 5 illustrates another sequence-flow method 500 illustrating interactions between the network device 302, the first datacenter 304a, and the second datacenter 304b in the VoIP communication system 300 of FIG. 3 in accordance with one or more embodiments disclosed herein. In particular, the method 500 of FIG. 5 illustrates an example method of detecting an accounting event at one datacenter 304 and updating state information at each datacenter 304 based on the detected event.

To illustrate, in step 502, a user may add funds to a user account. For example, the user may use the network device 302 to add money to a user account. In some embodiments, the user uses an electronic device 308, such as a computer or mobile device to add money to the user account. For example, the user may use a web portal associated with the VoIP system 300 to view, add, withdraw, or transfer money from their user account.

The first datacenter 304a can detect an event triggered by the user's action. For example, step 506 can include the first datacenter 304a detecting the user adding funds to the user account. For instance, the event detector 330a on the first datacenter 304a may detect the accounting event triggered by the user's action.

Step 506 may include the first datacenter 304a creating an event message indicating the addition of funds. The event message may include event information, such as the amount of money added to the user account. In addition, the event message may include information about the event, such as the time the first datacenter 304a detected and/or created the event message, the identification number of the event message, the priority of the event message, etc. As described above, the event detector 330a on the first datacenter 304a can create the event message.

Step 508 may include the first datacenter 304a sending the event message indicating the addition of funds to the second datacenter 304b. In addition, the first datacenter 304a may send the event message to other datacenters 304 within the VoIP system 300. For example, the event communicator 332a on the first datacenter 304a may send the event message to the other datacenters 304. In this manner, each datacenter 304 within the VoIP system 300 receives the event message, including the datacenter 304 that detected and sent out the event message. As described above, the event communicator 332a on the first datacenter 304a can create the event message. In addition, each datacenter 304 that receives the event message may organize the event message in an event queue for processing, as described above.

Step 510 may include processing the event message indicating the addition of funds. For example, step 510 may include updating state information for the user account associated with user to reflect the addition of funds. For instance, an event processor 336 can process the event message and update state information associated with a user account at each datacenter 304 to reflect the updated account balance. In particular, step 510a may include the first datacenter 304a updating the state information to indicate the addition of funds for the user account at the first datacenter 304a. In step, 510b, the second datacenter 304b can update the state information to indicate the addition of funds for the user account at the second datacenter 304b. In this manner, each datacenter 304 within the VoIP system 300 can maintain an individual copy of state information reflecting the user account balance for each context.

In one or more embodiments, a user can request services provided by the VoIP system 330. For example, step 512 includes a user requesting a service that is associated with a service charge. The user may request the service using network device 302. For instance, the user may call a long-distance number or request directory assistance.

Step 514 may include the second datacenter 304b detecting the service request event. For example, the second datacenter 304b can detect requesting service that is associated with a service charge. For instance, the event detector 330b on the second datacenter 304b can detect the accounting event triggered by the user's action.

In step 516, the second datacenter 304b can determine the available balance of the user account. For instance, when a user requests to use a service that is associated with a service charge, the VoIP system 300 may verify that the user has sufficient funds in their user account to pay for the services. For example, the second datacenter 304b checks the locally stored state information to identify the current balance of the user account rather than having to inquire from a remote service provider. If the user does not have sufficient funds in the user account, the user can be prompted to add additional funds or notified that the service requested by the user is no longer available due to insufficient funds.

In VoIP systems 300 where each network device 302 can connect to one or multiple datacenters 304, additional safeguards can be established to prevent one or more users from withdrawing more funds than are available. Because events are not processed in real-time at each datacenter 304, state information conflicts may potentially arise when the two or more users perform conflicting actions around the same time at different datacenters 304. As such, the VoIP system 300 can established safeguards to prevent conflicting events, such as overdrawing, from occurring.

As an example of a conflicting event, a first user and a second user may be associated with the same user account. The first user may be connected, via a network device 302, to the first datacenter 304a. The second user may be connected, via a different network device 302, to the second datacenter 304b. The first user may perform an action that costs $7, when the account balance is $10. The first datacenter 304a may detect the event, create an event message, and notify the second datacenter 304b of the $7 deduction. However, until the second datacenter 304b receives and processes the event message from the first datacenter 304a, the state information at the second datacenter 304b reflects that user account is $10. In the time between when the first user spends the $7 and when the second datacenter 304b updates its state information to reflect the accounting change, the second user may perform an action that costs $5. When either the first datacenter 304a or the second datacenter 304b processes both events, the user account balance may be overdrawn.

To prevent this type of event conflict from occurring, in one or more embodiments, the VoIP system 300 may allow allocate the user account balance between the multiple datacenters 304. For example, the VoIP system 300 may allocate a percentage of the account balance to each datacenter 304. For instance, the total allocation percentage may equal 100%. In other instances, the total allocation percentage is less than 100%. For example, if there are five datacenters 304, the VoIP system 300 allocates each datacenter 304 one-fifth, or twenty percent (20%), of the user account balance. In this manner, even if each datacenter 304 sends out event messages deducting the maximum amount allocated to each datacenter 304 for a user account, the VoIP system 300 will not overdraw funds from the user account.

In one or more embodiments, when a datacenter 304 sends out an event message indicating an increase or decrease to the user account balance, the VoIP system 300 may reallocate the allocation amount for each datacenter 304. For example, if there are two datacenters 304 within the VoIP system 300, the VoIP system 300 can allocate 50%, or half of the balance in a user account to each datacenter 304. For instance, if the user account balance is $100, the VoIP system 300 can allocate $50 to each datacenter 304. Accordingly, as long as each datacenter 304 does not allow an event over $50, the VoIP system 300 will not overdraw on funds from the user account, which may incur an additional fee. When a user spends $10 on a service at the first datacenter 304a, the first datacenter 304a creates an event message indicating that $10 has been used from the user account. Both the first datacenter 304a and the second datacenter 304b process the event message and update the total user account balance to $90. At this point, the VoIP system 300 can reallocate each datacenter to $45, or 50% of the new user account balance. This process can be repeated as funds are added and used form the user account. In this manner, event conflicts are avoided because each time an event occurs, each datacenter 304 receives an event messages and updates the state information associated with the context.

Alternatively, the VoIP system 300 may allocate a user account's balance using other methods and approaches. For example, the VoIP system 300 may allocate a fixed amount of the user account balance to each datacenter 304, such as $1 per event. In some instances, a user action can create multiple events. For instance, when a user calls longs distance, each minute the user talks on the call may trigger an event costing $0.10. Thus, a 100 minute call costs $10.00. Rather than send one event message indicating a $10.00 deduction, the datacenter 304 detecting each event triggered by the call can send minute-by-minute event messages to the other datacenters 304 within the VoIP system 300, which allows each datacenter 304 to continuously update state information for the user account. This embodiment is particularly beneficial when a large number of users are drawing funds from the user account at the same time because this embodiment can prevent overdrawing funds from a user account.

As another example, the VoIP system 300 may allocate a portion of a user account's balance to each datacenter 304 based on other factors, such as the number of the network devices 302 associated that are connected to a datacenter per user account verses the total number of network devices within the VoIP system 300 associated with the user account. In other words, if a user account has 100 network devices associated with it and 30 network devices are connected to the first datacenter 304a, the VoIP system 300 may allocate 30% of the user account's balance to the first datacenter 304a.

Returning to FIG. 5, in step 516, the second datacenter 304b may determine the available balance. As described above, the second datacenter 304b may determine an allocated amount of the user account budget for which the second datacenter 304b is authorized to provide service. If the service requested by the user is within the available authorized amount, the second datacenter 304b can perform the service, as shown in step 518.

Step 520 may include the second datacenter 304b creating an event message indicating the cost of the service performed. The event message may include event information, such as the balance deduction from the user account. As described above, the event message may also include information about the event. Further, the event detector 330b on the second datacenter 304b can create the event message.

Step 522 may include the second datacenter 304b sending the event message indicating the balance deduction to the first datacenter 304a. For example, the event communicator 332b on the second datacenter 304b may send the event message to each datacenters 304 within the VoIP system 300. Each datacenter 304 that receives the event message may organize the event message in an event queue 334 for processing by an event processer 336.

Step 524 may include processing the event message indicating the balance deduction to the user account. For example, step 524 may include updating state information for the user account associated with user to reflect the balance deduction. For instance, an event processor 336 can process the event message and update state information associated with a user account at each datacenter 304 to reflect the updated account balance. In particular, step 524a may include the first datacenter 304a updating the state information to indicate the balance deduction to the user account at the first datacenter 304a. In step, 524b, the second datacenter 304b can update the state information to indicate the balance deduction to the user account at the second datacenter 304b.

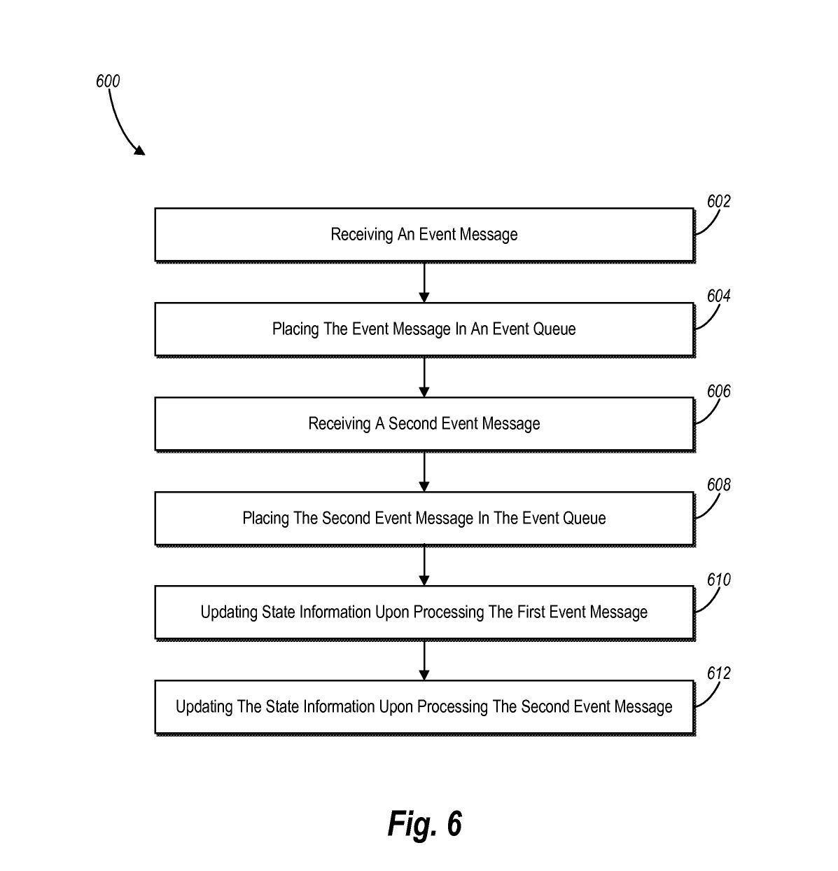

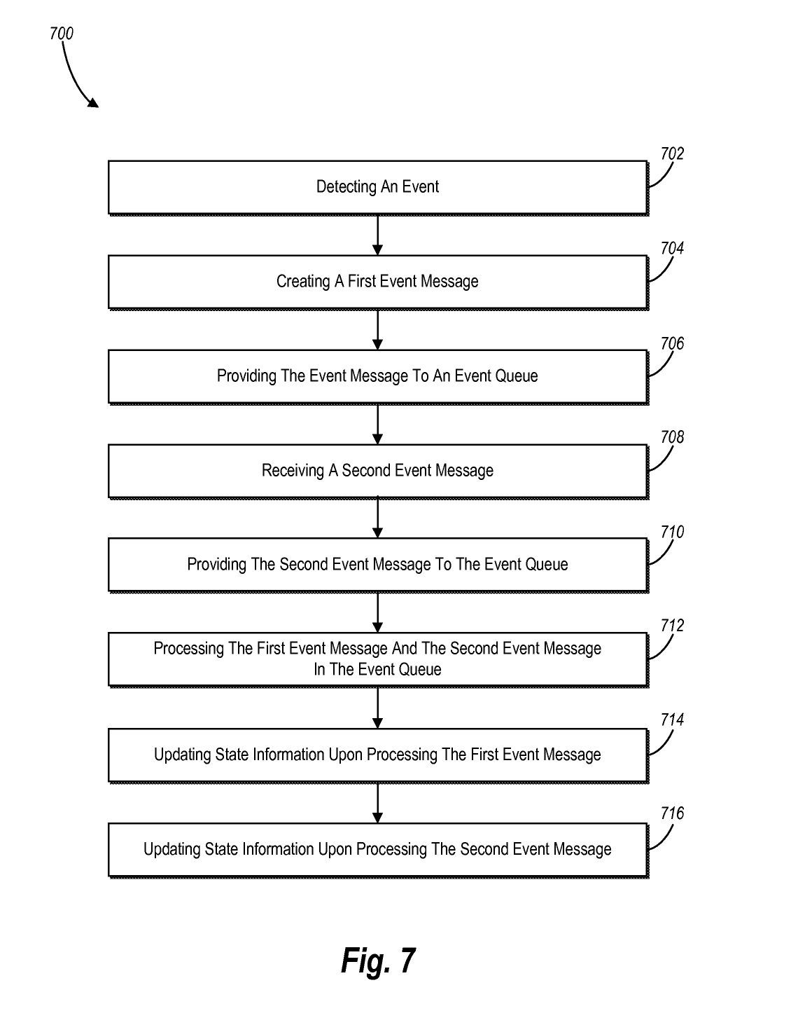

FIGS. 1-5, the corresponding text, and the examples, provide a number of different systems and devices for providing a network based communication system. In addition to the foregoing, embodiments also can be described in terms of flowcharts comprising acts and steps in a method for accomplishing a particular result. For example, FIGS. 6-7 illustrate flowcharts of example methods in accordance with one or more embodiments. The methods described in relation to FIGS. 6-7 may be performed with less or more steps/acts or the steps/acts may be performed in differing orders. Additionally, the steps/acts described herein may be repeated or performed in parallel with one another or in parallel with different instances of the same or similar steps/acts. One or more of the steps shown in FIGS. 6-7 may be performed by any component or combination of components of system 300.

FIG. 6 illustrates another method 600 of processing event messages at one or more datacenters 304 within the network-based communication system 100. Step 602 can include receiving an event message. In particular, step 602 can include receiving a first event message associated with a first context from a first datacenter 304a. For example, the first datacenter 304a can receive an event message associated with a first user account from the second datacenter 304b or another datacenter 304, as described herein. Alternatively, the first datacenter 304a can receive an event message from itself when sending the event message to other datacenters 304 within a VoIP system 300.

Step 604 can include placing the event message in an event queue 334. For example, the first datacenter 304a can receive the event message and place the event message in an event queue 334a, in any suitable manner, such as described herein.

Step 606 can include receiving a second event message. In particular, step 606 can include receiving a second event message associated with a second context from a second datacenter 304b. For example, the second datacenter 304b can receive a second event message from the first datacenter 304a or another datacenter 304, as described herein. Alternatively, the second datacenter 304b can receive a second event message from itself when sending the event message to other datacenters 304 within a VoIP system 300.

Step 608 can include placing the second event message in the event queue 334. For example, the first datacenter 304a can receive the second event message and place the second event message in the event queue 334a, in any suitable manner, such as described herein. In some embodiments, the first datacenter 304a can place the first event message and the second event message in the same or different event queues.

Step 610 can include updating state information upon processing the first event message. In particular, step 610 can include updating state information corresponding with the first context upon processing the first event message in the event queue 334. For example, the first datacenter 304a can update state information in a state information database 324a corresponding to the first user account upon processing the first event message in the event queue 334a, as described herein.

Step 612 can include updating the state information upon processing the second event message. In particular, step 612 can include updating the state information corresponding to the second context upon processing the second event message in the event queue 334. For example, the first datacenter 304a can update state information in a state information database 324a corresponding to the second user account upon processing the second event message in the event queue 334a, as described herein.

FIG. 7 illustrates another exemplary method 800 of processing event messages at one or more datacenters 304 within the network-based communication system 100. To illustrate, step 702 can include detecting an event. In particular, step 704 can include detecting a first event associated with a first context. For example, the first datacenter 304a can detect an event in any suitable manner, as described herein. For instance, the first datacenter 304a can detect an event that occurs at a network device 302 or at an electronic device 308.

Step 704 can include creating a first event message. In particular, step 704 can include creating a first event message that includes first event information based on the first event. For example, the first datacenter 304a can create an event message based on the detected event. For instance, an event processor 336a on the first datacenter 304a can create the event message, as described herein.

Step 706 can include providing the event message to an event queue 334. For example, the first datacenter 304a can provide the event message to an event queue 334a, in any suitable manner, such as described herein.

Step 708 can include receiving a second event message. In particular, step 708 can include receiving a second event message from a second datacenter 304b that includes second event information based on a second event associated with a second context. For example, the first datacenter 304a can receive a second event message from the second datacenter 304b or another datacenter 304, as described herein.

Step 710 can include providing the second event message to the event queue. For example, the first datacenter 304a can receive the second event message and provide the second event message to the event queue 334a, in any suitable manner, such as described herein.

Step 712 can include processing the first event message and the second event message in the event queue 334. For example, an event processor 336 can process event messages in the event queue 336 as disclosed herein.

Step 714 can include updating state information upon processing the first event message. In particular, step 714 can include updating state information associated with the first context based on the first event information upon processing the first event message. For example, the first datacenter 304a can update state information in a state information database 324a corresponding to the first user account upon processing the first event message in the event queue 334a, as described herein.

Step 716 can include updating state information upon processing the second event message. In particular, step 716 can include updating state information associated with the second context based on the second event information upon processing the second event message. For example, the first datacenter 304a can update state information in a state information database 324a corresponding to the second user account upon processing the second event message in the event queue 334a, as described herein.

FIG. 8 illustrates, in block diagram form, an exemplary computing device 800 that may be configured to perform one or more of the processes described above. One will appreciate that system 100, and/or VoIP system 300 each comprises one or more computing devices in accordance with implementations of computing device 800, such as network devices 102, 302, datacenters 104, 304, and/or electronic devices 308. As shown by FIG. 8, the computing device can comprise a processor 802, a memory 804, a storage device 806, an I/O interface 808, and a communication interface 810, which may be communicatively coupled by way of communication infrastructure 812. While an exemplary computing device 800 is shown in FIG. 8, the components illustrated in FIG. 8 are not intended to be limiting. Additional or alternative components may be used in other embodiments. Furthermore, in certain embodiments, a computing device 800 can include fewer components than those shown in FIG. 8. Components of computing device 800 shown in FIG. 8 will now be described in additional detail.

In particular embodiments, processor 802 includes hardware for executing instructions, such as those making up a computer program. As an example and not by way of limitation, to execute instructions, processor 802 may retrieve (or fetch) the instructions from an internal register, an internal cache, memory 804, or storage device 806 and decode and execute them. In particular embodiments, processor 802 may include one or more internal caches for data, instructions, or addresses. As an example and not by way of limitation, processor 802 may include one or more instruction caches, one or more data caches, and one or more translation lookaside buffers (“TLBs”). Instructions in the instruction caches may be copies of instructions in memory 804 or storage 806.

Memory 804 may be used for storing data, metadata, and programs for execution by the processor(s). Memory 804 may include one or more of volatile and non-volatile memories, such as random access memory (“RAM”), read only memory (“ROM”), a solid-state disk (“SSD”), flash, phase change memory (“PCM”), or other types of data storage. Memory 804 may be internal or distributed memory.

Storage device 806 includes storage for storing data or instructions. As an example and not by way of limitation, storage device 806 can comprise a non-transitory storage medium described above. Storage device 806 may include a hard disk drive (“HDD”), a floppy disk drive, flash memory, an optical disc, a magneto-optical disc, magnetic tape, or a universal serial bus (“USB”) drive or a combination of two or more of these. Storage device 806 may include removable or non-removable (or fixed) media, where appropriate. Storage device 806 may be internal or external to the computing device 800. In particular embodiments, storage device 806 is non-volatile, solid-state memory. In other embodiments, Storage device 806 includes read-only memory (“ROM”). Where appropriate, this ROM may be mask programmed ROM, programmable ROM (“PROM”), erasable PROM (“EPROM”), electrically erasable PROM (“EEPROM”), electrically alterable ROM (“EAROM”), or flash memory or a combination of two or more of these.

I/O interface 808 allows a user to provide input to, receive output from, and otherwise transfer data to and receive data from computing device 800. I/O interface 808 may include a mouse, a keypad or a keyboard, a touch screen, a camera, an optical scanner, network interface, modem, other known I/O devices or a combination of such I/O interfaces. I/O interface 808 may include one or more devices for presenting output to a user, including, but not limited to, a graphics engine, a display (e.g., a display screen), one or more output drivers (e.g., display drivers), one or more audio speakers, and one or more audio drivers. In certain embodiments, I/O interface 808 is configured to provide graphical data to a display for presentation to a user. The graphical data may be representative of one or more graphical user interfaces and/or any other graphical content as may serve a particular implementation.

Communication interface 810 can include hardware, software, or both. In any event, communication interface 810 can provide one or more interfaces for communication (such as, for example, packet-based communication) between computing device 800 and one or more other computing devices or networks. As an example and not by way of limitation, communication interface 810 may include a network interface controller (“NIC”) or network adapter for communicating with an Ethernet or other wire-based network or a wireless NIC (“WNIC”) or wireless adapter for communicating with a wireless network, such as WI-FI.

Additionally or alternatively, communication interface 810 may facilitate communications with an ad hoc network, a personal area network (“PAN”), a local area network (“LAN”), a wide area network (“WAN”), a metropolitan area network (“MAN”), a personal network, or one or more portions of the Internet or a combination of two or more of these. One or more portions of one or more of these networks may be wired or wireless. As an example, communication interface 810 may facilitate communications with a wireless PAN (“WPAN”) (such as, for example, a BLUETOOTH WPAN), a WI-FI network, a WI-MAX network, a cellular telephone network (such as, for example, a global system for mobile communications (“GSM”) network), a satellite network, a navigation network, a broadband network, a narrowband network, the Internet, a local area network, or any other networks capable of carrying data and/or communications signals between a network device 102 and one or more datacenters 104.

To illustrate, the communication interface may communicate using any communication platforms and technologies suitable for transporting data and/or communication signals, including known communication technologies, devices, media, and protocols supportive of remote data communications, examples of which include, but are not limited to, data transmission media, communications devices, transmission control protocol (“TCP”), internet protocol (“IP”), file transfer protocol (“FTP”), telnet, hypertext transfer protocol (“HTTP”), hypertext transfer protocol secure (“HTTPS”), session initiation protocol (“SIP”), simple object access protocol (“SOAP”), extensible mark-up language (“XML”) and variations thereof, simple mail transfer protocol (“SMTP”), real-time transport protocol (“RTP”), user datagram protocol (“UDP”), global system for mobile communications (“GSM”) technologies, enhanced data rates for GSM evolution (“EDGE”) technologies, code division multiple access (“CDMA”) technologies, time division multiple access (“TDMA”) technologies, short message service (“SMS”), multimedia message service (“MMS”), radio frequency (“RF”) signaling technologies, wireless communication technologies, in-band and out-of-band signaling technologies, and other suitable communications networks and technologies.

Communication infrastructure 812 may include hardware, software, or both that couples components of computing device 800 to each other. As an example and not by way of limitation, communication infrastructure 812 may include an accelerated graphics port (“AGP”) or other graphics bus, an enhanced industry standard architecture (“EISA”) bus, a front-side bus (“FSB”), a hypertransport (“HT”) interconnect, an industry standard architecture (“ISA”) bus, an infiniband interconnect, a low-pin-count (“LPC”) bus, a memory bus, a micro channel architecture (“MCA”) bus, a peripheral component interconnect (“PCI”) bus, a PCI-Express (“PCIe”) bus, a serial advanced technology attachment (“SATA”) bus, a video electronics standards association local (“VLB”) bus, or another suitable bus or a combination thereof.

FIG. 9 illustrates an example network environment of a telecommunications system 900 according to the principles described herein. In particular, the telecommunications system 900 may facilitate both network-based communication systems as well as circuited-switched traditional communication systems. For example, the telecommunications system 900 may allow a user calling from a traditional landline to converse with a user using a VoIP device. In addition, while FIG. 9 illustrates exemplary components and devices according to one embodiment, other embodiments may omit, add to, reorder, and/or modify any of the components and devices shown in FIG. 9.

The telecommunication system 900 may include a PTSN 950 and an IP/packet network 950. The PTSN 950 and the IP/packet network 952 may be connected via a network, such as the Internet 906. In some configurations, the PTSN 950 and/or the IP/packet network 952 may be connected to the Internet 906 via gateways 954ab. For example, gateway 954b may be a signaling gateway and/or a media gateway. For instance, the signaling gateway processes and translates bidirectional SIP signals, and the media gateway handles real-time transport protocol communications. In addition, network trunks may interconnect the PTSN 950, the Internet 906, and the IP/packet network 950.

The PSTN 950 may connect to one or more PSTN devices 956. For example, a switch 958 may connect the one or more PSTN devices 956 to the PSTN 950. PSTN devices 956 may include a variety of devices ranging from traditional landline devices to mobile/cellular devices.

The PSTN 950 may include, but is not limited to telephone lines, fiber optic cables, microwave transmission links, cellular networks, communications satellites, and undersea telephone cables. Switching centers may interconnect each of this components and networks. Further, the PSTN 950 may be analog or digital. In addition, the PSTN 950 may use protocols such as common channel signaling system 7 (“CCS7”). CCS7 is a set of protocols used in the PSTN 950 to setup and tear down communications between subscribers (i.e., users).

As illustrated in FIG. 9, the telecommunications system 900 may include an IP/packet network 952. The IP/packet network 952 may be part of a network-based communication system, such as a VoIP communication system. VoIP systems are generally known for transmitting voice packets between users. However, VoIP systems also handle other forms of communication, such as video, audio, photographs, multimedia, data, etc. For example, VoIP systems provide communication services for telephone calls, faxes, text messages, and voice-messages.

The IP/packet network 952 provides communications services between users over the Internet 906 rather than using a traditional PSTN 950. However, VoIP systems also allow users to communicate with users using PSTN 950. Thus, a subscriber using a network device 902 may communicate with a subscriber using a PSTN device 956. Furthermore, VoIP systems allow users to communicate with each other without accessing the PSTN 950.

Embodiments disclosed herein may comprise or utilize a special purpose or general-purpose computer including computer hardware, such as, for example, one or more processors and system memory, as discussed in greater detail below. Embodiments within the scope disclosed herein also include physical and other computer-readable media for carrying or storing computer-executable instructions and/or data structures. In particular, one or more of the processes described herein may be implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., a memory, etc.), and executes those instructions, thereby performing one or more processes, including one or more of the processes described herein.

Computer-readable media can be any available media that can be accessed by a general purpose or special purpose computer system. Computer-readable media that store computer-executable instructions are non-transitory computer-readable storage media (devices). Computer-readable media that carry computer-executable instructions are transmission media. Thus, by way of example, and not limitation, embodiments of the invention can comprise at least two distinctly different kinds of computer-readable media: non-transitory computer-readable storage media (devices) and transmission media.

Non-transitory computer-readable storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to non-transitory computer-readable storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. Thus, it should be understood that non-transitory computer-readable storage media (devices) can be included in computer system components that also (or even primarily) utilize transmission media.

Computer-executable instructions comprise, for example, instructions and data which, when executed at a processor, cause a general purpose computer, special purpose computer, or special purpose processing device to perform a certain function or group of functions. In some embodiments, computer-executable instructions are executed on a general purpose computer to turn the general purpose computer into a special purpose computer implementing elements of the invention. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The invention may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Embodiments of the invention can also be implemented in cloud computing environments. In this description, “cloud computing” is defined as a model for enabling on-demand network access to a shared pool of configurable computing resources. For example, cloud computing can be employed in the marketplace to offer ubiquitous and convenient on-demand access to the shared pool of configurable computing resources. The shared pool of configurable computing resources can be rapidly provisioned via virtualization and released with low management effort or service provider interaction, and then scaled accordingly.

A cloud-computing model can be composed of various characteristics such as, for example, on-demand self-service, broad network access, resource pooling, rapid elasticity, measured service, and so forth. A cloud-computing model can also expose various service models, such as, for example, Software as a Service (“SaaS”), Platform as a Service (“PaaS”), and Infrastructure as a Service (“IaaS”). A cloud-computing model can also be deployed using different deployment models such as private cloud, community cloud, public cloud, hybrid cloud, and so forth. In this description and in the claims, a “cloud-computing environment” is an environment in which cloud computing is employed.

As illustrated in FIG. 9, the IP/packet network 952 may also include network devices 902 devices and datacenters 904. The network devices 902 devices and datacenters 904 illustrated in FIG. 9 may be exemplary configurations of the network device 202 and datacenters 204 described above. For example, example of network devices 902 include a variety of devices, such as personal computers, a tablet computer, handheld devices, mobile phones, smartphones, a personal digital assistants (“PDA”), in- or out-of-car navigation systems, and other electronic access devices. In addition, the network device 902 may be part of an enterprise environment, such as a professional business exchange (“PBX”), a small office/home office environment, or a home/personal environment.

As briefly described above, network devices 902 may include dedicated devices and soft devices. Dedicated devices are commonly designed and appear like a digital business telephone. Soft devices or softphones refer to software installed on a computing device. This software utilizes microphone, audio, and/or video capabilities of the computing device and provides traditional calling functionality to a user, operated via a user interface.

Datacenter 904 may facilitate communications between network devices 902. For example, datacenter 904 registers devices, stores device identification and address information, tracks current communications, and logs past communications, etc., as described above. In addition, datacenters 904 also assists network devices in provisioning, signaling, and establishing user communications via a media bridge.

In the case of multiple datacenters 904, one datacenter 904 may communicate with another datacenter 904. For example, one datacenter 904 may send gathered network device 902 information to the other datacenter 904. In particular, when a datacenter 904 registers a network device 902, that datacenter 904 may send the address information to the other datacenters 904 located on the IP/packet network 952. Accordingly, each datacenter 904 may communicate with others datacenters 904 and assist the IP/packet network 952 in balancing network and processing loads. Further, the datacenters 904 may assist the IP/packet network 952 to ensure that communication sessions between network devices 902 do not fail by communicating with each other.

As illustrated, the network devices 902 and the datacenters 904 may be connected to the IP/packet network 952 via switches 960a-b. Switches 960a-b manage the flow of data across the IP/packet network 952 by transmitting a received message to the device for which the message was intended. In some configurations, the switches 960a-b may also perform router functions. Further, while not illustrated, one or more modems may be in electronic communication with the switches 960a-b.

In addition, the IP/packet network 952 may facilitate session control and signaling protocols to control the signaling, set-up, and teardown of communication sessions. In particular, the IP/packet network 952 may employ SIP signaling. For example, the IP/packet network 952 may include a SIP server that processes and directs signaling between the network devices 902 and the IP/packet network 952. Other protocols may also be employed. For example, the IP/packet network 952 may adhere to protocols found in the H.225, H.323, and/or H.245 standards, as published by the International Telecommunications Union, available at the following URL—http://www.itu.int/publications.

In particular, session initiation protocol (“SIP”) is a standard proposed by the Internet Engineering Task Force (“EITF”) for establishing, modifying, and terminating multimedia IP sessions. Specifically, SIP is a client/server protocol in which clients issue requests and servers answer with responses. Currently, SIP defines requests or methods, including INVITE, ACK, OPTIONS, REGISTER, CANCEL, and BYE.

The INVITE request is used to ask for the presence of a contacted party in a multimedia session. The ACK method is sent to acknowledge a new connection. The OPTIONS request is used to get information about the capabilities of the server. In response to an OPTIONS request, the server returns the methods that it supports. The REGISTER method informs a server about the current location of the user. The CANCEL method terminates parallel searches. The client sends a BYE method to leave a session. For example, for a communication session between two network devices 902, the BYE method terminates the communication session.

Once signaling is established, the IP/packet network 952 may establish a media bridge. The media bridge caries the payload data for a communication session. The media bridge is separate for the device signaling. For example, in a videoconference, the media bride includes audio and video data for a communication session.

As described above a datacenter 904 may facilitate a media bridge path for a network device 902. For example, when one network device 902 attempts the contact a second network device 902, the datacenter 904 may execute the signaling and also determine a media bridge between the two network devices 902. Further, the datacenter 904 may provide alternative media bridge paths to the network devices 902 in the event that the primary media bridge weakens, for example, below a threshold level, or even fails.

In the foregoing specification, the invention has been described with reference to specific exemplary embodiments thereof. Various embodiments and aspects of the invention(s) are described with reference to details discussed herein, and the accompanying drawings illustrate the various embodiments. The description above and drawings are illustrative of the invention and are not to be construed as limiting the invention. Numerous specific details are described to provide a thorough understanding of various embodiments disclosed herein.

The present invention may be embodied in other specific forms without departing from its spirit or essential characteristics. The described embodiments are to be considered in all respects only as illustrative and not restrictive. For example, the methods described herein may be performed with less or more steps/acts or the steps/acts may be performed in differing orders. Additionally, the steps/acts described herein may be repeated or performed in parallel with one another or in parallel with different instances of the same or similar steps/acts. The scope of the invention is, therefore, indicated by the appended claims rather than by the foregoing description. All changes that come within the meaning and range of equivalency of the claims are to be embraced within their scope.

What is claimed is:

1. A method comprising:
receiving a first event message associated with a first context from a first datacenter;
placing the first event message in an event queue;
receiving a second event message associated with a second context from a second datacenter;
placing the second event message in the event queue;
updating, by at least one processor, state information corresponding with the first context upon processing the first event message in the event queue; and
updating the state information corresponding to the second context upon processing the second event message in the event queue.

2. The method of claim 1, wherein the first context and the second context are the same user account.

3. The method of claim 1, wherein the first context and the second context are the different contexts.

4. The method of claim 1, wherein the first event and the second event are the same event type.

5. The method of claim 1, wherein the second event has a higher priority than the first event.

6. The method of claim 5, wherein the second event is processed before first event.

7. The method of claim 1, further comprising:
sending a first confirmation event message to the first datacenter upon processing the first event message; and
sending a second confirmation event message to the second datacenter upon processing the second event message.

8. The method of claim 1, further comprising processing events in the order in each event is placed in the event queue.

9. The method of claim 1, further comprising processing events based on a timestamp included in each event message.

10. The method of claim 1, further comprising increasing processing capabilities when the number of events in the event queue surpass a predetermined number.

11. A method comprising:
detecting a first event associated with a first context;
creating, by at least one processor, a first event message that includes first event information based on the first event;
providing the first event message to an event queue;
receiving a second event message from a second datacenter that includes second event information based on a second event associated with a second context;
providing the second event message to the event queue;
processing the first event message and the second event message in the event queue;
updating state information associated with the first context based on the first event information upon processing the first event message; and
updating state information associated with the second context based on the second event information upon processing the second event message.

12. The method of claim 11, further comprising:
sending the first event message to the second datacenter; and
receiving a confirmation from the second datacenter that the first event message has been processed at the second datacenter.

13. The method of claim 11, wherein the first event is triggered by user action.

14. The method of claim 11, further comprising generating an archival copy of the state information associated with the first context.

15. The method of claim 14, further comprising generating the archival copy of the state information associated with the first context after a predetermined amount of time has elapsed.

16. The method of claim 14, further comprising generating the archival copy of the state information associated with the first context after a predetermined number of processing updates occur to the state information associated with the first context.

17. The method of claim 14, further comprising receiving a second copy of the state information associated with the first context from the second datacenter.

18. The method of claim 17, further comprising comparing the copy of the state information associated with the first context with the second copy of the state information associated with the first user account received from the second datacenter.

19. A system comprising:
at least one processor; and
at least one non-transitory computer readable storage medium storing instructions thereon that, when executed by the at least one processor, cause the system to:
detect a first event associated with a first user account;
create a first event message that includes first event information based on the first event;
provide the first event message to an event queue;
receive a second event message from a second datacenter that includes second event information based on a second event associated with a second user account;
provide the second event message to the event queue;
process the first event message and the second event message in the event queue;
update state information associated with the first user account based on the first event information upon processing the first event message; and
update state information associated with the second user account based on the second event information upon processing the second event message.

20. The system of claim 19, wherein the first event is triggered by a system event.
